(19) United States
(12) Patent Application Publication
(10) Pub. No.: US 2020/0213566 A1
(43) Pub. Date: Jul. 2, 2020

(54) DISPLAY DEVICE, DISPLAY SYSTEM, AND DISPLAY METHOD

(71) Applicant: SEIKO EPSON CORPORATION, Tokyo (JP)

(72) Inventor: Toshiyuki SAKAI, Matsumoto-shi (JP)

(73) Assignee: SEIKO EPSON CORPORATION, Tokyo (JP)

(21) Appl. No.: 16/724,550

(22) Filed: Dec. 23, 2019

(30) Foreign Application Priority Data
Dec. 26, 2018 (JP) 2018-242242

(51) Int. Cl. H04N 9/31; H04N 9/885

(52) U.S. Cl. CPC H04N 9/3147; G03B 21/006; H04N 9/312; H04N 9/885

(57) ABSTRACT

A projector includes: an image information input unit to which an SD card storing image information and a group ID is coupled; a screen displaying an image based on the image information; a communication unit coupled via a network to another projector having an SD card storing image information, the communication unit communicating with the another projector; and a control unit determining whether a group ID corresponding to the group ID is stored in the SD card or not, based on communication by the communication unit, the control unit synchronizing a display of the image by the screen and a display of an image based on the image information by the another projector when the group ID is stored in the SD card.

The present application is based on, and claims priority from JP Application Serial Number 2018-242242, filed Dec. 26, 2018, the disclosure of which is hereby incorporated by reference herein in its entirety.

### BACKGROUND

### 1. Technical Field

The present disclosure relates to a display device, a display system, and a display method.

### 2. Related Art

A system that can cause a desired display device to display an image, from among a plurality of display devices coupled to a network, is known. For example, JP-A-2017-135490 describes constructing a multi-projection system as a display system, using projectors installed in the same room, of a plurality of projectors coupled to a network.

However, in the foregoing display system, a list of the plurality of projectors coupled to the network is presented to a user, and the user needs to select a desired projector from among them. Therefore, every time a projector is replaced, added or deleted, the user must carry out an operation to select a projector from the list again. This poses a problem in that user-friendliness is reduced.

### SUMMARY

A display device according to an aspect of the present disclosure includes: an interface to which a first storage device storing first image information and a first identifier is coupled; a display unit displaying a first image based on the first image information; a communication unit coupled via a network to another display device having a second storage device storing second image information, the communication unit communicating with the another display device; and a control unit determining whether a second identifier corresponding to the first identifier is stored in the second storage device or not, based on communication by the communication unit, the control unit synchronizing a display of the first image by the display unit and a display of a second image based on the second image information by the another display device when the second identifier is stored in the second storage device.

In the display device, the control unit may synchronize the display of the first image and the display of the second image when the second identifier is identical to the first identifier.

In the display device, the control unit may decide whether the display device is a master device or a slave device. When the display device is the master device, the control unit may cause the communication unit to transmit a first synchronization signal to the other display device and cause the display unit to display the first image synchronously with the first synchronization signal. When the display device is the slave device, the control unit may cause the display unit to display the first image synchronously with a second synchronization signal transmitted from the other display device to the communication unit.

In the display device, schedule information prescribing a timing of displaying the first image and the second image may be stored in the first storage device and the second storage device. When the display device is the master device, the control unit may cause the display unit to display the first image, based on the schedule information, and transmit the first synchronization signal to the other display device, based on the schedule information.

In the display device, when the display device is the slave device and the second synchronization signal is not transmitted from the other display device at a timing based on the schedule information, the control unit may decide again whether the display device is the master device or the slave device.

A display system according to an aspect of the present disclosure includes a first display device and a second display device coupled together via a network. The first display device has a first interface to which a first storage device storing first image information and a first identifier is coupled. The second display device has a second interface to which a second storage device storing second image information is coupled. The first display device includes: a display unit displaying a first image based on the first image information; a communication unit communicating with the second display device via the network; and a control unit determining whether a second identifier corresponding to the first identifier is stored in the second storage device or not, based on communication by the communication unit, the control unit synchronizing a display of the first image by the display unit and a display of a second image based on the second image information by the second display device when the second identifier is stored in the second storage device.

In the display system, the control unit may synchronize the display of the first image and the display of the second image when the second identifier is identical to the first identifier.

In the display system, the control unit may decide whether the first display device is a master device or a slave device. When the first display device is the master device, the control unit may cause the communication unit to transmit a first synchronization signal to the second display device and cause the display unit to display the first image synchronously with the first synchronization signal. When the first display device is the slave device, the control unit may cause the display unit to display the first image synchronously with a second synchronization signal transmitted from the second display device to the communication unit.

In the display system, schedule information prescribing a timing of displaying the first image and the second image may be stored in the first storage device and the second storage device. When the first display device is the master device, the control unit may cause the display unit to display the first image, based on the schedule information, and transmit the first synchronization signal to the second display device, based on the schedule information.

In the display system, when the first display device is the slave device and the second synchronization signal is not transmitted from the second display device at a timing based on the schedule information, the control unit may decide again whether the first display device is the master device or the slave device.

A display method by a display device according to an aspect of the present disclosure includes: causing the display device to couple to a first storage device, the first storage device storing first image information and a first identifier; causing the display device to communicate via a network with another display device having a second storage device storing second image information; determining whether a second identifier corresponding to the first identifier is stored in the second storage device or not; and synchronizing a display of the first image based on the first image information and a display of a second image based on the second image information by the another display device when the second identifier is stored in the second storage device.

In the display method, the display of the first image and the display of the second image may be synchronized with each other when the second identifier is identical to the first identifier.

In the display method, whether the display device is a master device or a slave device may be decided. When the display device is the master device, a first synchronization signal may be transmitted to the other display device and the first image may be displayed synchronously with the first synchronization signal. When the display device is the slave device, the first image may be displayed synchronously with a second synchronization signal transmitted from the other display device.

In the display method, schedule information prescribing a timing of displaying the first image and the second image may be stored in the first storage device and the second storage device. When the display device is the master device, the first image may be displayed based on the schedule information, and the first synchronization signal may be transmitted to the other display device, based on the schedule information.

In the display method, when the display device is the slave device and the second synchronization signal is not transmitted from the other display device at a timing based on the schedule information, whether the display device is the master device or the slave device may be decided again.

### BRIEF DESCRIPTION OF THE DRAWINGS

FIG. 1 is a schematic perspective view showing the configuration of a display system according to an embodiment.

FIG. 2 is a block diagram showing the configuration of a projector as a display device.

FIG. 3 is a flowchart showing a display method.

FIG. 4 is a flowchart showing a display method.

FIG. 5 is a table showing an example of a playlist.

FIG. 6 is a table showing an example of schedule information.

### DESCRIPTION OF EXEMPLARY EMBODIMENTS

A display device, a display system, and a display method according to an embodiment will now be described with reference to the drawings.

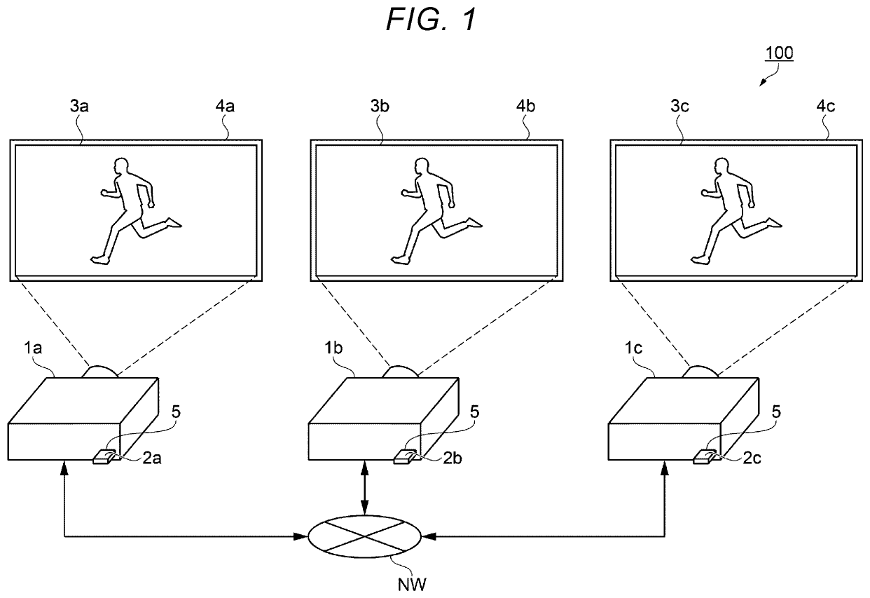

FIG. 1 is a schematic perspective view showing the configuration of the display system according to this embodiment. The configuration of the display system will now be described with reference to FIG. 1.

As shown in FIG. 1, a display system 100 is formed of a plurality of projectors 1a, 1b, 1c as display devices coupled in a communicable manner via a network NW.

Specifically, the display system 100 includes a first projector 1a, a second projector 1b, and a third projector 1c.

Each of the projectors 1a, 1b, 1c has a card slot 5. In the card slots 5 in this embodiment, SD cards 2a, 2b, 2c are installed. The SD cards 2a, 2b, 2c are storage media having a non-volatile memory and store image information of an image projected from the projectors 1a, 1b, 1c, or the like.

In the first projector 1a, the SD card 2a is installed. The first projector 1a projects an image 3a onto a screen 4a, based on the image information stored in the SD card 2a. In the second projector 1b, the SD card 2b is installed. The second projector 1b projects an image 3b onto a screen 4b, based on the image information stored in the SD card 2b. In the third projector 1c, the SD card 2c is installed. The third projector 1c projects an image 3c onto a screen 4c, based on the image information stored in the SD card 2c.

Projecting the image 3 based on the image information stored in the SD card 2 is also referred to as “playing back the image 3”. The projectors 1a, 1b, 1c have similar configurations to each other and therefore are referred to as the projector 1 when these projectors are not discriminated from each other. Also, the SD cards 2a, 2b, 2c have similar configurations to each other and therefore are referred to as the SD card 2 when these SD cards are not discriminated from each other. In this embodiment, the projectors 1a, 1b, 1c play back identical images synchronously with each other. That is, the images 3a, 3b, 3c are identical images and therefore are referred to as the image 3 when these images are not discriminated from each other. Playing back the image 3, that is, playing back the image 3 at the same timing by the plurality of projectors 1, is also referred to as “synchronous playback”.

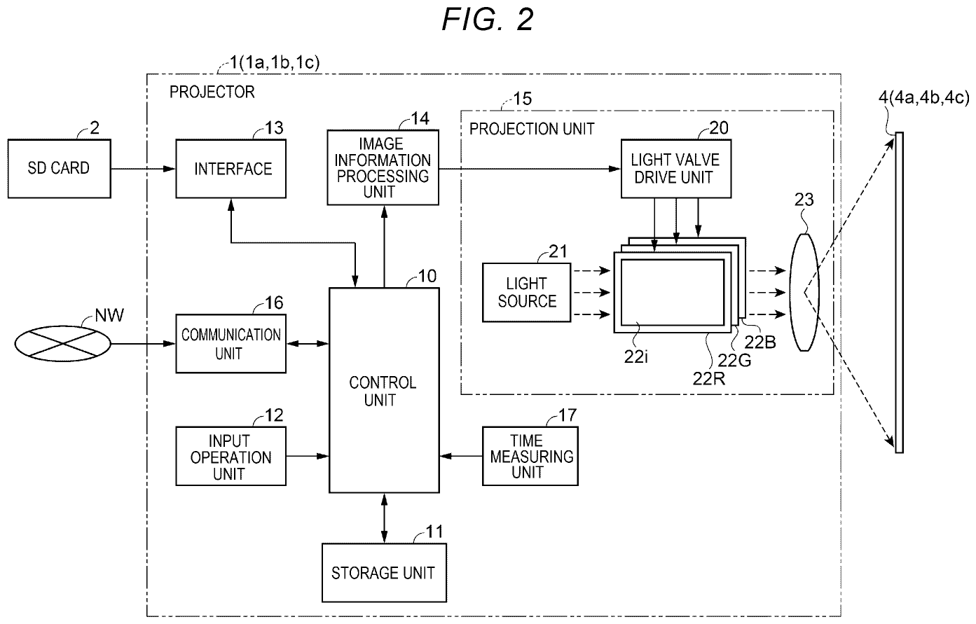

FIG. 2 is a block diagram showing the configuration of the projector. The configuration of the projector will now be described with reference to FIG. 2.

As shown in FIG. 2, the projector 1 has a control unit 10, a storage unit 11, an input operation unit 12, an interface 13, an image information processing unit 14, a projection unit 15 as a display unit, a communication unit 16, and a time measuring unit 17. The projector 1 projects the image 3 from the projection unit 15 onto the screen 4, based on image information read out from the SD card 2 via the interface 13.

The control unit 10 has one or a plurality of processors. The control unit 10 operates, for example, according to a control program stored in the storage unit 11 and thus comprehensively controls the operation of the projector 1.

The storage unit 11 has a memory such as a RAM (random-access memory) and a ROM (read-only memory). The RAM is used to temporarily store various data. The ROM stores a control program and control data or the like for controlling the operation of the projector 1.

The input operation unit 12 has a plurality of operation keys for the user to give various instructions to the projector 1. The operation keys provided in the input operation unit 12 include a power key for switching on and off the power supply, a menu key for displaying a menu for various settings, direction keys for selecting a menu item, and ten numeric keys corresponding to 0 to 9, and the like. Also, a remote controller (not illustrated) that can perform remote control may be used as the input operation unit 12. In this case, the remote controller emits an infrared operation signal corresponding to the content of an operation by the user, and a remote control signal receiving unit, not illustrated, receives the operation signal and transmits the operation signal to the control unit 10.

The interface 13 is electrically coupled to the SD card 2 installed in the card slot 5. The control unit 10 can read out image information and other information stored in the SD card 2 via the interface 13. When reading out the image information from the SD card 2, the control unit 10 outputs the read-out image information to the image information processing unit 14.

The image information processing unit 14 performs various kinds of processing of the image information inputted from the control unit 10 and outputs the processed image information to a light valve drive unit 20 of the projection unit 15. For example, the image information processing unit 14 performs processing to adjust the image quality such as brightness and contrast of the image information according to need.

The image information processing unit 14 may be formed of one or a plurality of processors or may be formed of a dedicated processing device such as an ASIC (application-specific integrated circuit) or FPGA (field-programmable gate array).

The communication unit 16 is coupled to the network NW such as a LAN (local area network) and communicates with the other projectors 1 via the network NW under the control of the control unit 10.

The time measuring unit 17 is a real-time clock and generates time information representing the current date and time.

The projection unit 15 has the light valve drive unit 20, a light source 21, three liquid crystal light valves 22R, 22G, 22B as light modulation devices, and a projection system 23, or the like. The projection unit 15 modulates the light emitted from the light source 21 by the liquid crystal light valves 22R, 22G, 22B to form image light, the projects this image light from the projection system 23 including at least one of a lens and a mirror, and thus displays an image on the screen 4.

The light source 21 includes a discharge-type light source lamp such as an ultra-high-pressure mercury lamp or metal halide lamp, or a solid-state light source such as a light-emitting diode or semiconductor laser. The light emitted from the light source 21 is converted into light having substantially even luminance distribution by an optical integration system, not illustrated, and is then separated into color light components of red, green, and blue, which are the primary colors of light by a color separation system, not illustrated. Subsequently, the color light components become incident on the corresponding liquid crystal light valves 22R, 22G, 22B.

Each of the liquid crystal light valves 22R, 22G, 22B is formed of a transmission-type liquid crystal panel or the like made up of a pair of transparent substrates with a liquid crystal enclosed between them. In each liquid crystal panel, a rectangular image forming area 22i made up of a plurality of pixels arranged into a matrix is formed. A drive voltage can be applied to the liquid crystal, pixel by pixel.

The light valve drive unit 20 forms an image in the image forming area 22i of the liquid crystal light valves 22R, 22G, 22B. Specifically, the light valve drive unit 20 applies a drive voltage corresponding to the image information inputted from the image information processing unit 14, to each pixel in the image forming area 22i, and thus sets each pixel to a light transmittance corresponding to the image information.

The light emitted from the light source 21 is modulated pixel by pixel by being transmitted through the image forming area 22i of the liquid crystal light valves 22R, 22G, 22B and thus forms image light corresponding to the image information for each color. The resulting image light of the respective colors is combined together pixel by pixel into image light representing a color image by a light combining system, not illustrated, and is projected in an enlarged form onto the screen 4 by the projection system 23. Thus, the image 3 based on the image information read out from the SD card 2 is displayed on the screen 4.

One or a plurality of pieces of image information is stored in the SD card 2. Also, playlist information, schedule information, and group ID or the like are stored in the SD card 2. The playlist information is information that defines a playlist prescribing a playback target image and its playback order or the like. One or a plurality of pieces of playlist information is stored in the SD card 2. Hereinafter, playing back an image prescribed by a playlist is also referred to as “playing back a playlist”. The schedule information is information that prescribes a timing of playing back each playlist. The schedule information defines a playback start date and time to start playback and a playback end date and time to end playback, or the like. The group ID is information that identifies a group made up of a plurality of projectors 1. In this embodiment, it is determined that the projectors 1 holding the same group ID belong to the same group.

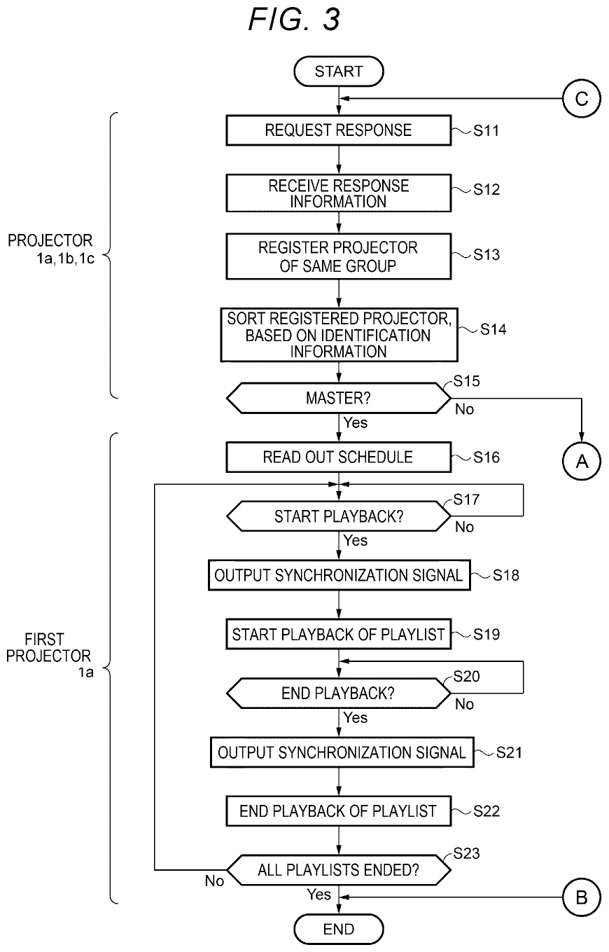

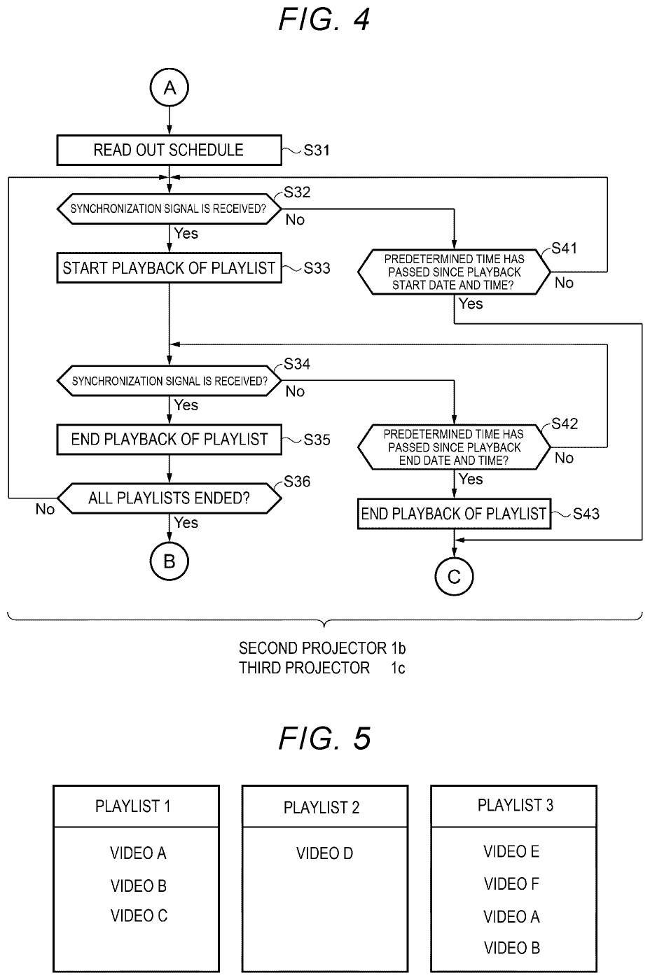

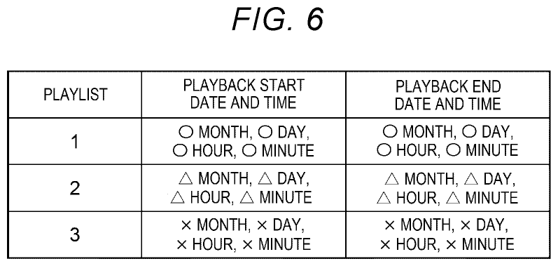

FIGS. 3 and 4 are flowchart showing a display method by the display system 100. FIG. 5 is a table showing an example of the playlist. FIG. 6 is a table showing an example of the schedule information. The display method will now be described with reference to FIGS. 3 to 5. The display system 100 in this embodiment is formed of the three projectors 1a, 1b, 1c, as an example.

As the user turns on the power supply of each projector 1a, 1b, 1c, the control unit 10 of each projector 1a, 1b, 1c starts operating according to the flow shown in FIG. 3. The control unit 10 repeats the operation according to this flow regularly or irregularly while the power supply is on.

As shown in FIG. 3, in step S11, the control unit 10 of the projector 1 requests a response from the other projectors 1 via the communication unit 16. Specifically, the control unit 10 issues a request command to request a response, to the projectors 1 coupled to the network NW. This request command includes a command requesting transmission of the identification information to identity each projector 1 and transmission of the group ID stored in the SD card 2 installed in each projector 1. As the identification information, for example, the IP address is used.

Although not illustrated in the drawing, the projector 1 receiving this request command transmits its own identification information and the group ID held in the SD card 2, as response information, to the projector 1 of the transmission source. The projector 1 that does not hold the group ID transmits response information representing that the projector 1 does not hold the group ID. In all the projectors 1 in this embodiment, the SD card 2 having the same image information, playlist information, schedule information, and group ID is installed. In other words, the same information is copied in all the SD cards 2.

In step S12, the communication unit 16 of the projector 1 receives the response information transmitted from the other projectors 1. Specifically, the projector 1 sequentially receives the identification information and the group ID transmitted from the other projectors 1.

In step S13, the control unit 10 of the projector 1 registers the projector 1 of the same group. Specifically, each projector 1 receives the response information via the communication unit 16 and registers the projector 1 holding the same group ID as its own group ID, as the same group in a registration list. The registration is stored in the storage unit 11. The projector 1's own identification information is registered in advance in the registration list.

In step S14, the control unit 10 of the projector 1 sorts the registered projector 1, based on the identification information. Specifically, the control unit 10 rearranges the projectors 1 holding the same group ID into the projectors 1a, 1b, 1c, based on the magnitude of the numbers forming the IP address. Thus, the projector 1 that comes first in the order after the sorting is a master device.

The identification information for sorting each projector is not limited to the IP address and may be, for example, the MAC address or a name given by the user. The projector may be sorted, based on these.

In step S15, the control unit 10 of the projector 1 determines whether the projector 1 itself is the master device or not. When the projector 1 is determined as the master device, the control unit 10 shifts the processing to step S16. When the projector 1 is not determined as the master device, the control unit 10 shifts the processing to step S31 shown in FIG. 4. The projector that is not determined as the master device is a slave device. The steps up to this point are executed similarly by all the projectors 1. Therefore, all the projectors 1 have the same registration list after the sorting. Thus, all the projectors 1 can discriminate which projector 1 is the master device and which projector 1 is the slave device, based on their own registration lists. In this embodiment, it is assumed that the first projector 1a is determined as the master device and that the second projector 1b and the third projector 1c are determined as the slave device.

In step S16, the control unit 10 of the first projector 1a determined as the master device reads out the schedule information stored in the SD card 2. The schedule information is information prescribing the timing of projecting the image 3, as described above, and includes information about at what hour and what minute on what day of what month the playlist starts being played back, or the like.

FIG. 5 is a table showing an example of the playlist information. As shown in FIG. 5, for example, three pieces of playlist information respectively defining three playlists, that is, a playlist 1, a playlist 2, and a playlist 3, are stored in the SD card 2. For each playlist, which image should be played back in what order is prescribed. For the playlist 1, it is prescribed that a video A, a video B, and a video C should be played back in this order. For the playlist 2, it is prescribed that only a video D should be played back. For the playlist 3, it is prescribed that a video E, a video F, the video A, and the video B should be played back in this order. In the SD card 2, image information corresponding to these videos is separately stored. These playlists may be decided by the user or may be randomly decided by a computer. The images prescribed by the playlist are not limited to the videos and may be still images. When the projector 1 is configured to be able to playback an audio, the playlists may include an audio.

FIG. 6 is a table showing an example of the schedule information. As shown in FIG. 6, as the schedule information, one or a plurality of playlists to be automatically played back according to date and time is registered. The schedule information prescribes a playback start date and time, which is the date and time when each playlist should be played back, and a playback end date and time, which is the date and time when the playback of each playlist should be ended. The control unit 10 of the first projector 1a determined as the master device controls the start and end of the playback of each playlist, based on the schedule information.

In step S17, the control unit 10 of the first projector 1a determines whether the current date and time has reached the playback start date and time of one of the playlists or not, based on the read-out schedule information and time information inputted from the time measuring unit 17. When the current date and time has reached the playback start date and time of a playlist, the control unit 10 shifts the processing to step S18. When the current date and time has not reached the playback start date and time, the control unit 10 repeatedly performs the processing of step S17.

In step S18, the control unit 10 of the first projector 1a outputs a synchronization signal to the second projector 1b and the third projector 1c, which are the slave devices, via the communication unit 16. The synchronization signal in this case is a start signal to start playback of the playlist.

In step S19, the control unit 10 of the first projector 1a starts playback of the playlist synchronously with the transmitted synchronization signal so that the playlist is played back at the same timing as in the slave devices. Specifically, the control unit 10 reads out image information of a playback target video prescribed by the playlist, from the SD card 2 via the interface 13, and outputs the image information to the image information processing unit 14 synchronously with the synchronization signal. Thus, projection of the image 3 based on the image information from the projection unit 15, that is, playback of the video, is started. When playback of one video is finished, the control unit 10 reads out image information of the next video from the SD card 2 and starts playback according to the playlist information. When there is no next video, that is, when playback of the last video in the playlist is finished, the control unit 10 starts playback of the first video in the playlist. The control unit 10 repeats this operation until the playback end date and time prescribed by the schedule information comes.

In step S20, the control unit 10 of the first projector 1a determines whether the current date and time has reached the playback end date and time of the playlist or not, based on the schedule information and the time information. When it is determined that the current date and time has reached the playback end date and time, the control unit 10 shifts the processing to step S21. When the current date and time has not reached the playback end date and time, the control unit 10 repeatedly performs the processing of step S20.

In step S21, the control unit 10 of the first projector 1a outputs a synchronization signal to the second projector 1b and the third projector 1c via the communication unit 16. The synchronization signal in this case is an end signal to end playback of the playlist.

In step S22, the control unit 10 of the first projector 1a ends the playback of the playlist synchronously with the transmitted synchronization signal so that the playback of the playlist ends at the same timing as in the slave devices.

In step S23, the control unit 10 of the first projector 1a determines whether the playback of all the playlists registered in the schedule information has ended or not. When the playback of all the playlists has ended, the control unit 10 ends the flow. When the playback of all the playlists has not ended, the control unit 10 shifts the processing to step S17.

As shown in FIG. 4, in step S31, the control unit 10 of the projector 1 that is determined not as the master device in step S15, that is, the second projector 1b and the third projector 1c, which are the slave devices, reads out the schedule information stored in the respective SD cards 2. The control unit 10 recognizes a playlist that should be played back next, based on the read-out schedule information.

In step S32, the control unit 10 of the second projector 1b and the third projector 1c determines whether the synchronization signal to start playback of a playlist, transmitted from the first projector 1a, is received by the communication unit 16 or not. When it is determined that the synchronization signal is received, the control unit 10 shifts the processing to step S33. When it is determined that the synchronization signal is not received, the control unit 10 shifts the processing to step S41.

In step S33, the control unit 10 of the second projector 1b and the third projector 1c starts playback of the playlist synchronously with the received synchronization signal so that the playlist is played back at the same timing as in the master device. The second projector 1b and the third projector 1c have received the synchronization signal for start from the first projector 1a in step S32. Therefore, the first to third projectors 1a to 1c can synchronously play back the playlist at the same timing. That is, all the projectors 1a, 1b, 1c play back the same image 3 at the same timing.

In step S34, the control unit 10 of the second projector 1b and the third projector 1c determines whether the synchronization signal to end the playback of the playlist, transmitted from the first projector 1a, is received by the communication unit 16 or not. When the synchronization signal is received, the control unit 10 shifts the processing to step S35. When the synchronization signal is not received, the control unit 10 shifts the processing to step S42.

In step S35, the control unit 10 of the second projector 1b and the third projector 1c ends the playback of the playlist synchronously with the received synchronization signal so that the playback of the playlist ends at the same timing as in the master device. The second projector 1b and the third projector 1c have received the synchronization signal to end the playback from the first projector 1a in step S34. Therefore, the first to third projectors 1a to 1c can end the playback of the playlist at the same timing.

In step S36, the control unit 10 of the second projector 1b and the third projector 1c determines whether the playback of all the playlists registered in the schedule information has ended or not. When the playback of all the playlists has ended, the control unit 10 ends the flow. When the playback of all the playlists has not ended, the control unit 10 shifts the processing to step S32.

When the synchronization signal to start playback of a playlist is not received in step S32 and the processing shifts to step S41, the control unit 10 of the second projector 1b and the third projector 1c determines whether a predetermined time has passed since the playback start date and time or not, based on the schedule information held by the respective projectors. When the predetermined time has passed, the control unit 10 determines that an abnormality has occurred in the master device, then shifts the processing to step S11, and selects a master device again from among the projectors 1 of the same group coupled to the network NW. An example of such a case is the case where the first projector 1a as the master device has a breakdown, the case where the power supply is off, the case where the first projector 1a leaves the network NW, or the like. When the predetermined time has not passed, the control unit 10 shifts the processing to step S32. When a master device is set again and synchronous playback is available, the control unit 10 starts synchronous playback until the playlist ends, even after the lapse of the playback time.

When the synchronization signal to end the playback of the playlist is not received in step S34 and the processing shifts to step S42, the control unit 10 of the second projector 1b and the third projector 1c determines whether a predetermined time has passed since the playback end date and time or not, based on their own schedule information. When the predetermined time has passed, the control unit 10 determines that an abnormality has occurred in the master device, and shifts the processing to step S43. When the predetermined time has not passed, the control unit 10 shifts the processing to step S34.

In step S43, the control unit 10 of the second projector 1b and the third projector 1c ends the playback of the playlist, the shifts the processing to step S11, and selects a master device again from among the projectors 1 of the same group coupled to the network NW.

As described above, the projector 1, the display system 100, and the display method in this embodiment can achieve the following effects.

(1) According to the embodiment, the group ID is stored in the SD card 2 of the first to third projectors 1a to 1c. Therefore, these projectors can be identified as the same group to perform synchronous playback on the network, based on the group ID. Also, the master device and the slave device are automatically decided from the group. Therefore, for example, even when the combination of the projectors 1 to perform synchronous playback is changed, the complicated work for the user such as designating the projectors 1 again can be omitted. This can improve user-friendliness.

(2) According to the embodiment, when an abnormality occurs in the master device and therefore a synchronization signal is not transmitted to the slave devices, the master device and the slave devices are set again. Therefore, failure to project the image 3 from all the projectors 1 in the display system 100 due to the abnormality in the master device can be prevented.

(3) According to the embodiment, playback of a playlist is started based on the synchronization signal. Therefore, even when there is a discrepancy between the times held by the respective projectors, playback can be started at the same timing.

In the embodiment, each projector 1a, 1b, 1c is equivalent to a first display device, and the projector 1 that each projector 1a, 1b, 1c regards as not itself is equivalent to a second display device or another display device. The interface 13, the SD card 2, the group ID, the image information, the image 3, and the synchronization signal related to the projector 1 equivalent to the first display device are equivalent respectively to a first interface, a first storage device, a first identifier, first image information, a first image, and a first synchronization signal. The interface 13, the SD card 2, the group ID, the image information, the image 3, and the synchronization signal related to the projector 1 equivalent to the second display device are equivalent respectively to a second interface, a second storage device, a second identifier, second image information, a second image, and a second synchronization signal.

### MODIFICATION EXAMPLES

The embodiment may be altered as follows.

In the embodiment, an example where a playlist is played back according to the schedule information stored in the SD card 2 is described. However, this is not limiting. For example, a playlist may be played back, based on an instruction by the user using the input operation unit 12.

First, the user issues a command to playback a playlist via the input operation unit 12 of an arbitrary projector 1. Specifically, the user operates a numeric key corresponding to the playlist to be played back, of the numeric keys provided in the input operation unit 12. Next, the projector 1 receiving the operation determines whether the projector 1 itself is the master device or not. When the projector 1 is the master device, the projector 1 communicates the operated numeric key to the projector 1 of the slave device and subsequently transmits a synchronization signal to start playback of the playlist. The master device and the slave device start playback of the playlist corresponding to the operated numeric key synchronously with the synchronization signal. Meanwhile, when the projector 1 receiving the operation is the slave device, the slave device communicates the operated numeric key to the master device. Subsequently, the master device communicates the operated numeric key to each slave device and transmits a synchronization signal. Then, the master device and the slave device start playback of the playlist corresponding to the operated numeric key synchronously with the synchronization signal. Thus, the master device and the slave device can synchronously play back the same playlist.

In the embodiment, the number of projectors forming the display system 100 is three. However, this is not limiting. The number of projectors may be two, or four or more. Also, the display system may be formed of ten or twenty projectors.

In the embodiment, the SD card, which is a storage medium, is used as the storage device. However, this is not limiting. Other storage media such as a USB memory may be used. Also, an external storage device may be coupled to and used with the projector 1. The storage unit 11 provided in the projector 1 may be used as the storage device.

In the embodiment, an example where all the projectors 1 in the display system 100 play back the same video is described. However, the projectors 1 are not limited to playing back the same video. For example, the projectors 1 may play back associated contents, that is, different videos. Also, a plurality of projectors 1 may be arranged in such a way that the projected images 3 are placed next to each other in the left-right direction, and the projectors 1 may project different images from each other. Thus, an image that is horizontally longer than usual can be played back.

In the embodiment, the synchronization signal is transmitted and received every time a playlist ends. However, this is not limiting. The synchronization signal may be transmitted and received for every video. Alternatively, the synchronization signal may be transmitted and received at the stage where all the playlists have ended.

In the embodiment, the group ID is held in the SD card. However, this is not limiting. The group ID may be held in the storage unit 11 of the projector 1.

In the embodiment, the group ID is held in order to discriminate the projector to perform synchronous playback. However, this is not limiting. A setting to synchronize a projector that does not have the group ID, or a setting to synchronize a projector located on the same network NW even without having the group ID, may be made.

A group ID that is different from the projector's own group ID but corresponds to the projector's own ID may be determined as the same group, and synchronous playback may be performed. For example, even when there are different group IDs such as “A1” and “A2”, the projector 1 having a group ID that begins with “A” can be determined as the same group.

Apart from the group ID, a synchronization flag indicating whether to perform synchronous playback or not may be stored in the SD card 2. Thus, the projector 1 having the same group ID and having a synchronization flag that indicates performing synchronous playback may be regarded as a synchronous playback target.

Also, whether to perform synchronous playback or not may be designated for each playlist registered in the schedule information. Thus, for example, at several shops, the same video is synchronously played back immediately after opening, and subsequently different videos may be played back from shop to shop. Then, the same video can be synchronously played back at all the shops before closing.

In the embodiment, of the projectors 1 holding the same group ID, the projector 1 that comes first is defined as the master device, based on the magnitude of the numbers forming the IP address. However, this is not limiting. The projector 1 that comes last may be defined as the master device. That is, the projectors 1 may be sorted based on a rule designated by the user, and the projector 1 at a place in the order designated by the user may be defined as the master device.

In the embodiment, the transmission-type liquid crystal light valves 22R, 22G, 22B are used as the light modulation devices. However, a reflection-type light modulation device such as a reflection-type liquid crystal light valve can be used. Also, a digital mirror device or the like that controls the exiting direction of incident light for each micromirror as a pixel and thus modulates the light emitted from the light source 21 can be used. The configuration having a plurality of light modulation devices corresponding to respective colors is not limiting, either. A single light modulation device that modulates a plurality of color light beams in a time-divisional manner may be employed.

In the embodiment, the projector 1 is described as an example of the display device. However, the display device is not limited to the projector 1 and may be other image display devices such as a liquid crystal display or organic EL (electroluminescence) display.

The contents derived from the embodiment are described below.

A display device includes: an interface to which a first storage device storing first image information and a first identifier is coupled; a display unit displaying a first image based on the first image information; a communication unit coupled via a network to another display device having a second storage device storing second image information, the communication unit communicating with the another display device; and a control unit determining whether a second identifier corresponding to the first identifier is stored in the second storage device or not, based on communication by the communication unit, the control unit synchronizing a display of the first image by the display unit and a display of a second image based on the second image information by the another display device when the second identifier is stored in the second storage device.

According to this configuration, the display device having the second storage device where the second identifier corresponding to the first identifier is stored is selected as another display device displaying an image synchronously with this display device. Therefore, storing the second identifier in the second storage device eliminates the need of an operation to select the display device and thus can improve user-friendliness.

In the display device, the control unit may synchronize the display of the first image and the display of the second image when the second identifier is identical to the first identifier.

According to this configuration, the displays of the images by the display devices are synchronized with each other when the first identifier and the second identifier are identical to each other. Therefore, there is no need of an operation to select the display device and user-friendliness can be improved.

In the display device, the control unit may decide whether the display device is a master device or a slave device. When the display device is the master device, the control unit may cause the communication unit to transmit a first synchronization signal to the another display device and cause the display unit to display the first image synchronously with the first synchronization signal. When the display device is the slave device, the control unit may cause the display unit to display the first image synchronously with a second synchronization signal transmitted from the another display device to the communication unit.

According to this configuration, the transmission and reception of the synchronization signal is changed, based on whether the display device is the master device or the slave device. Therefore, the display of the first image by the display device and the display of the second image by the another display device can be properly synchronized with each other.

In the display device, schedule information prescribing a timing of displaying the first image and the second image may be stored in the first storage device and the second storage device. When the display device is the master device, the control unit may cause the display unit to display the first image, based on the schedule information, and transmit the first synchronization signal to the another display device, based on the schedule information.

According to this configuration, when the display device is the master device, the display device displays the first image based on the schedule information and transmits the first synchronization signal to the another display device. Therefore, the display device and the another display device can be made to display an image synchronously at a predetermined timing.

In the display device, when the display device is the slave device and the second synchronization signal is not transmitted from the another display device at a timing based on the schedule information, the control unit may decide again whether the display device is the master device or the slave device.

According to this configuration, when the display device is the slave device and the synchronization signal is not transmitted from the another display device, whether the display device is the master device or the slave device is decided again. Therefore, even when the master device has a breakdown or leaves the network, the displays by the other display devices can be synchronized with each other.

A display system includes a first display device and a second display device coupled together via a network. The first display device has a first interface to which a first storage device storing first image information and a first identifier is coupled. The second display device has a second interface to which a second storage device storing second image information is coupled. The first display device includes: a display unit displaying a first image based on the first image information; a communication unit communicating with the second display device via the network; and a control unit determining whether a second identifier corresponding to the first identifier is stored in the second storage device or not, based on communication by the communication unit, the control unit synchronizing a display of the first image by the display unit and a display of a second image based on the second image information by the second display device when the second identifier is stored in the second storage device.

According to this configuration, the second display device having the second storage device where the second identifier is stored is selected as a display device displaying an image synchronously with the first display device. Therefore, storing the second identifier in the second storage device eliminates the need of an operation to select the second display device and thus can improve user-friendliness.

In the display system, the control unit may synchronize the display of the first image and the display of the second image when the second identifier is identical to the first identifier.

According to this configuration, the display of the first image by the first display device and the display of the second image by the second display device synchronized with each other when the first identifier and the second identifier are identical to each other. Therefore, there is no need of an operation to select the display device and user-friendliness can be improved.

In the display system, the control unit may decide whether the first display device is a master device or a slave device. When the first display device is the master device, the control unit may cause the communication unit to transmit a first synchronization signal to the second display device and cause the display unit to display the first image synchronously with the first synchronization signal. When the first display device is the slave device, the control unit may cause the display unit to display the first image synchronously with a second synchronization signal transmitted from the second display device to the communication unit.

According to this configuration, the transmission and reception of the synchronization signal is changed, based on whether the display device is the master device or the slave device. Therefore, the display of the first image by the display device and the display of the second image by the other display device can be properly synchronized with each other.

In the display system, schedule information prescribing a timing of displaying the first image and the second image may be stored in the first storage device and the second storage device. When the first display device is the master device, the control unit may cause the display unit to display the first image, based on the schedule information, and transmit the first synchronization signal to the second display device, based on the schedule information.

According to this configuration, when the display device is the master device, the display device displays the first image based on the schedule information and transmits the first synchronization signal to the other display device. Therefore, the display device and the other display device can be made to display an image synchronously at a predetermined timing.

In the display system, when the first display device is the slave device and the second synchronization signal is not transmitted from the second display device at a timing based on the schedule information, the control unit may decide again whether the first display device is the master device or the slave device.

According to this configuration, when the display device is the slave device and the synchronization signal is not transmitted from the other display device, whether the display device is the master device or the slave device is decided again. Therefore, even when the master device has a breakdown or leaves the network, the displays by the other display devices can be synchronized with each other.

A display method by a display device includes: having a first storage device coupled, the first storage device storing first image information and a first identifier; communicating via a network with another display device having a second storage device storing second image information; determining whether a second identifier corresponding to the first identifier is stored in the second storage device or not; and synchronizing a display of the first image based on the first image information and a display of a second image based on the second image information by the another display device when the second identifier is stored in the second storage device.

According to this method, the display device having the second storage device where the second identifier is stored is selected as another display device displaying an image synchronously with this display device. Therefore, storing the second identifier in the second storage device eliminates the need of an operation to select the display device and thus can improve user-friendliness.

In the display method, the display of the first image and the display of the second image may be synchronized with each other when the second identifier is identical to the first identifier.

According to this method, the displays of the images by the display devices are synchronized with each other when the first identifier and the second identifier are identical to each other. Therefore, there is no need of an operation to select the display device and user-friendliness can be improved.

In the display method, whether the display device is a master device or a slave device may be decided. When the display device is the master device, a first synchronization signal may be transmitted to the other display device and the first image may be displayed synchronously with the first synchronization signal. When the display device is the slave device, the first image may be displayed synchronously with a second synchronization signal transmitted from the other display device.

According to this method, the transmission and reception of the synchronization signal is changed, based on whether the display device is the master device or the slave device. Therefore, the display of the first image by the display device and the display of the second image by the other display device can be properly synchronized with each other.

In the display method, schedule information prescribing a timing of displaying the first image and the second image may be stored in the first storage device and the second storage device. When the display device is the master device, the first image may be displayed based on the schedule information, and the first synchronization signal may be transmitted to the other display device, based on the schedule information.

According to this method, when the display device is the master device, the first image is displayed based on the schedule information, and the first synchronization signal is transmitted to the other display device. Therefore, the display device and the other display device can be made to display an image synchronously at a predetermined timing.

In the display method, when the display device is the slave device and the second synchronization signal is not transmitted from the other display device at a timing based on the schedule information, whether the display device is the master device or the slave device may be decided again.

According to this method, when the display device is the slave device and the synchronization signal is not transmitted from the other display device, whether the display device is the master device or the slave device is decided again. Therefore, even when the master device has a breakdown or leaves the network, the displays by the other display devices can be synchronized with each other.

What is claimed is:

1. A display device comprising:
an interface to which a first storage device storing first image information and a first identifier is coupled;
a display unit displaying a first image based on the first image information;
a communication unit coupled via a network to another display device having a second storage device storing second image information, the communication unit communicating with the other display device; and
a control unit determining whether a second identifier corresponding to the first identifier is stored in the second storage device or not, based on communication by the communication unit, the control unit synchronizing a display of the first image by the display unit and a display of a second image based on the second image information by the another display device when the second identifier is stored in the second storage device.

2. The display device according to claim 1, wherein
the control unit synchronizes the display of the first image and the display of the second image when the second identifier is identical to the first identifier.

3. The display device according to claim 1, wherein
the control unit decides whether the display device is a master device or a slave device,
when the display device is the master device, the control unit causes the communication unit to transmit a first synchronization signal to the other display device and causes the display unit to display the first image synchronously with the first synchronization signal, and
when the display device is the slave device, the control unit causes the display unit to display the first image synchronously with a second synchronization signal transmitted from the other display device to the communication unit.

4. The display device according to claim 3, wherein
schedule information prescribing a timing of displaying the first image and the second image is stored in the first storage device and the second storage device, and
when the display device is the master device, the control unit causes the display unit to display the first image, based on the schedule information, and transmits the first synchronization signal to the other display device, based on the schedule information.

5. The display device according to claim 4, wherein
when the display device is the slave device and the second synchronization signal is not transmitted from the another display device at a timing based on the schedule information, the control unit decides again whether the display device is the master device or the slave device.

6. A display system comprising a first display device and a second display device coupled together via a network,
the first display device having a first interface to which a first storage device storing first image information and a first identifier is coupled,
the second display device having a second interface to which a second storage device storing second image information is coupled,
the first display device comprising:
a display unit displaying a first image based on the first image information;
a communication unit communicating with the second display device via the network; and
a control unit determining whether a second identifier corresponding to the first identifier is stored in the second storage device or not, based on communication by the communication unit, the control unit synchronizing a display of the first image by the display unit and a display of a second image based on the second image information by the second display device when the second identifier is stored in the second storage device.

7. The display system according to claim 6, wherein
the control unit synchronizes the display of the first image and the display of the second image when the second identifier is identical to the first identifier.

8. The display system according to claim 6, wherein
the control unit decides whether the first display device is a master device or a slave device,
when the first display device is the master device, the control unit causes the communication unit to transmit a first synchronization signal to the second display device and causes the display unit to display the first image synchronously with the first synchronization signal, and
when the first display device is the slave device, the control unit causes the display unit to display the first image synchronously with a second synchronization signal transmitted from the second display device to the communication unit.

9. The display system according to claim 8, wherein
schedule information prescribing a timing of displaying the first image and the second image is stored in the first storage device and the second storage device, and
when the first display device is the master device, the control unit causes the display unit to display the first image, based on the schedule information, and transmits the first synchronization signal to the second display device, based on the schedule information.

10. The display system according to claim 9, wherein
when the first display device is the slave device and the second synchronization signal is not transmitted from the second display device at a timing based on the schedule information, the control unit decides again whether the first display device is the master device or the slave device.

11. A display method by a display device, the method comprising:
causing the display device to couple to a first storage device, the first storage device storing first image information and a first identifier;
causing the display device to communicate via a network with another display device having a second storage device storing second image information;
determining whether a second identifier corresponding to the first identifier is stored in the second storage device or not; and
synchronizing a display of the first image based on the first image information and a display of a second image based on the second image information by the other display device when the second identifier is stored in the second storage device.

12. The display method according to claim 11, wherein
the display of the first image and the display of the second image are synchronized with each other when the second identifier is identical to the first identifier.

13. The display method according to claim 11, wherein
whether the display device is a master device or a slave device is decided,
when the display device is the master device, a first synchronization signal is transmitted to the other display device and the first image is displayed synchronously with the first synchronization signal, and
when the display device is the slave device, the first image is displayed synchronously with a second synchronization signal transmitted from the other display device.

14. The display method according to claim 13, wherein
schedule information prescribing a timing of displaying the first image and the second image is stored in the first storage device and the second storage device, and
when the display device is the master device, the first image is displayed based on the schedule information, and the first synchronization signal is transmitted to the other display device, based on the schedule information.

15. The display method according to claim 14, wherein
when the display device is the slave device and the second synchronization signal is not transmitted from the other display device at a timing based on the schedule information, whether the display device is the master device or the slave device is decided again.
